(19) United States
(12) Patent Application Publication
(10) Pub. No.: US 2005/0201599 A1
(43) Pub. Date: Sep. 15, 2005

(54) Diagnostic imaging support apparatus and diagnostic imaging support method

(75) Inventor: Koh Matsui, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/070,814

(22) Filed: Mar. 2, 2005

(30) Foreign Application Priority Data
Mar. 11, 2004 (JP) 2004-069419

(51) Int. Cl. G06K 9/00

(52) U.S. Cl. 382/128

(57) ABSTRACT

A diagnostic imaging support apparatus includes: an abnormal shadow candidate detection unit to perform detection of an abnormal shadow candidate by performing determination as to whether or not a shadow contained in a medical image obtained by imaging a subject is an abnormal shadow; and an image display unit to display the medical image thereon, wherein the abnormal shadow candidate detection unit includes a judging unit to judge a state of the detection of the abnormal shadow candidate, and a changing unit to change a determination manner of the determination as to whether or not the shadow is an abnormal shadow based on the judged state of the detection.

### BACKGROUND OF THE INVENTION

1. Field of the Invention

The present invention relates to a diagnostic imaging support apparatus and a diagnostic imaging support method, and particularly to a diagnostic imaging support apparatus and a diagnostic imaging support method to facilitate diagnosis by a doctor, upon interpretation of a medical image.

2. Description of the Related Art

In the medical field, digitalization of medical images has been realized, and medical image data generated by a CR (Computed Radiography) device, a CT (Computed Tomography) device, an MRI (Magnetic Resonance Imaging) device and the like is displayed on an image display device such as a CRT (Cathode Ray Tube). The doctor interprets the medical image displayed on the image display device, and performs diagnosis by observing the state and time course of a lesion area.

Further, there has been developed a Computer-Aided Diagnosis (CAD) device to automatically detect abnormal shadow candidate(s) of breast cancer, lung cancer or the like through image data analysis using a digital image processing technology, thus reducing burden on a doctor in interpretation of the image (for example, refer to JP-Tokukai-2002-112985A). The CAD device provides the doctor with information on the detected abnormal shadow candidates, thereby supporting the doctor in diagnosis.

However, concerning the detected abnormal shadow candidates on the image, there is no absolute difference in features between true positive (lesion) and false positive (normal tissue) in many cases. Moreover, since the noise amount, the contrast amount of a lesion area, and the like on the image vary according to the imaging conditions of each facility and the individual difference among the subjects. Therefore, it has been difficult to set a threshold value for abnormal shadow candidate discrimination. For example, when the detection number of abnormal shadow candidates is apparently larger than the practically possible number of lesions, there is a possibility that noises or normal tissues have been erroneously detected as lesions. Such a situation was not assumed in the technique disclosed in JP-Tokukai-2002-112985A.

### SUMMARY OF THE INVENTION

The present invention has been made in view of the above-described problem in the earlier development, and an object of the invention is to provide a diagnostic imaging support apparatus and a diagnostic imaging support method capable of detecting abnormal shadow candidates with high accuracy.

In order to solve the above problem, according to a first aspect of the invention, a diagnostic imaging support apparatus comprises: an abnormal shadow candidate detection unit to perform detection of an abnormal shadow candidate by performing determination as to whether or not a shadow contained in a medical image obtained by imaging a subject is an abnormal shadow; and an image display unit to display the medical image thereon, wherein the abnormal shadow candidate detection unit comprises a judging unit to judge a state of the detection of the abnormal shadow candidate, and a changing unit to change a determination manner of the determination as to whether or not the shadow is an abnormal shadow based on the judged state of the detection.

According to the first aspect of the invention, since a state of the detection of the abnormal shadow candidate is judged, and a determination manner of the determination as to whether or not the shadow is an abnormal shadow is changed based on the state of the detection of the abnormal shadow candidate, it is possible to detect the abnormal shadow candidate with high accuracy.

A target of the detection of the abnormal shadow candidate may be a cluster of microcalcification in a breast.

According to the invention, the detection of the abnormal shadow candidate in which a target thereof is a cluster of microcalcification in a breast can be performed with high accuracy.

A target of the detection of the abnormal shadow candidate may be a tumor density lesion in a breast.

According to the invention, the detection of the abnormal shadow candidate in which a target thereof is a tumor density lesion in a breast can be performed with high accuracy.

It is preferable that the judging unit judges the state of the detection based on any one of or a combination of the detection number of the abnormal shadow candidate, a distributed state of the abnormal shadow candidate, a statistical value of a feature quantity of the abnormal shadow candidate, and a calculation time of the feature quantity.

According to the invention, it is possible to judge the state of the detection based on any one of or a combination of the detection number of the abnormal shadow candidate, a distributed state of the abnormal shadow candidate, a statistical value of a feature quantity of the abnormal shadow candidate, and a calculation time of the feature quantity.

It is preferable that the changing unit changes the determination manner based on any one of or a combination of a condition for imaging of the subject, subject information on the subject, a feature quantity of the abnormal shadow candidate, and an image state of the medical image.

According to the invention, it is possible to change the determination manner based on any one of or a combination of a condition for imaging, subject information, a feature quantity of the abnormal shadow candidate, and an image state of the medical image.

It is preferable that the changing unit changes the determination manner based on a predetermined set condition.

According to the invention, it is possible to change the determination manner based on a predetermined set condition.

It is preferable that the changing unit changes a threshold value used for feature quantity analysis, or a threshold value used for multivariate analysis which uses a plurality of feature quantities, when performing the determination as to whether or not the shadow is an abnormal shadow.

According to the invention, it is possible to detect the abnormal shadow candidate by changing a threshold value used for feature quantity analysis, or a threshold value used for multivariate analysis which uses a plurality of feature quantities, when performing the determination as to whether or not the shadow is an abnormal shadow.

It is preferable that the changing unit changes an algorithm.

According to the invention, it is possible to detect the abnormal shadow candidate by changing an algorithm.

It is preferable that the apparatus further comprises: a recording unit to record any one of the number of changing of a determination manner by the changing unit, a kind of the changed determination manner, and a criterion of changing the determination manner; or a display unit to display any one of the number of changing of a determination manner by the changing unit, a kind of the changed determination manner, and a criterion of changing the determination manner.

According to the invention, since any one of the number of changing of a determination manner, a kind of the changed determination manner, and a criterion of changing the determination manner is recorded or displayed, it is possible to notify any one of the number of changing of a determination manner of determining the abnormal shadow candidate, a kind of the changed determination manner, and a criterion of changing the determination manner, to the user.

According to a second aspect of the invention, a diagnostic imaging support method comprises: detecting an abnormal shadow candidate by performing determination as to whether or not a shadow contained in a medical image obtained by imaging a subject is an abnormal shadow; and displaying the medical image, wherein the detecting comprises judging a state of the detecting of the abnormal shadow candidate, and changing a determination manner of the determination as to whether or not the shadow is an abnormal shadow based on the judged state of the detecting.

According to the second aspect of the invention, since a state of the detecting of the abnormal shadow candidate is judged, and a determination manner of the determination as to whether or not the shadow is an abnormal shadow is changed based on the state of the detecting of the abnormal shadow candidate, it is possible to detect the abnormal shadow candidate with high accuracy.

A target of the detecting of the abnormal shadow candidate may be a cluster of microcalcification in a breast.

According to the invention, the detecting of the abnormal shadow candidate in which a target thereof is a cluster of microcalcification in a breast can be performed with high accuracy.

A target of the detecting of the abnormal shadow candidate may be a tumor density lesion in a breast.

According to the invention, the detecting of the abnormal shadow candidate in which a target thereof is a tumor density lesion in a breast can be performed with high accuracy.

It is preferable that the judging the state of the detecting is performed based on any one of or a combination of the detection number of the abnormal shadow candidate, a distributed state of the abnormal shadow candidate, a statistical value of a feature quantity of the abnormal shadow candidate, and a calculation time of the feature quantity.

According to the invention, it is possible to judge the state of the detecting based on any one of or a combination of the detection number of the abnormal shadow candidate, a distributed state of the abnormal shadow candidate, a statistical value of a feature quantity of the abnormal shadow candidate, and a calculation time of the feature quantity.

It is preferable that the changing the determination manner is performed based on any one of or a combination of a condition for imaging of the subject, subject information on the subject, a feature quantity of the abnormal shadow candidate, and an image state of the medical image.

According to the invention, it is possible to change the determination manner based on any one of or a combination of a condition for imaging, subject information, a feature quantity of the abnormal shadow candidate, and an image state of the medical image.

It is preferable that the changing the determination manner is performed based on a predetermined set condition.

According to the invention, it is possible to change the determination manner based on a predetermined set condition.

It is preferable that the changing changes a threshold value used for feature quantity analysis, or a threshold value used for multivariate analysis which uses a plurality of feature quantities, when performing the determination as to whether or not the shadow is an abnormal shadow.

According to the invention, it is possible to detect the abnormal shadow candidate by changing a threshold value used for feature quantity analysis, or a threshold value used for multivariate analysis which uses a plurality of feature quantities, when performing the determination as to whether or not the shadow is an abnormal shadow.

It is preferable that the changing changes an algorithm.

According to the invention, it is possible to detect the abnormal shadow candidate by changing an algorithm.

It is preferable that the method further comprises: recording any one of the number of changing of a determination manner by the changing unit, a kind of the changed determination manner, and a criterion of changing the determination manner; or displaying any one of the number of changing of a determination manner by the changing unit, a kind of the changed determination manner, and a criterion of changing the determination manner.

According to the invention, since any one of the number of changing of a determination manner, a kind of the changed determination manner, and a criterion of changing the determination manner is recorded or displayed, it is possible to notify any one of the number of changing of a determination manner of determining the abnormal shadow candidate, a kind of the changed determination manner, and a criterion of changing the determination manner, to the user.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a block diagram showing a schematic configuration of a diagnostic imaging support apparatus 1 according to an embodiment of the present invention;

FIG. 2 is a flow chart showing abnormal shadow candidate detection processing performed by the diagnostic imaging support apparatus 1;

FIG. 3 is a conceptual view of Mahalanobis distance in discriminant analysis;

FIG. 4 is a flow chart showing processing of changing an abnormal shadow candidate determination manner;

FIG. 5 is a conceptual view of feature space distribution;

FIG. 6A is a view showing a detection result of a cluster of microcalcification detected from a mammogram as an abnormal shadow candidate at first in the abnormal shadow candidate detection processing;

FIG. 6B is a view showing a detection result obtained by changing an abnormal shadow candidate determination manner and detecting abnormal shadow candidates again; and

FIG. 6C is a view showing a detection result obtained by further changing an abnormal shadow candidate determination manner and detecting abnormal shadow candidates again.

### DESCRIPTION OF THE PREFERRED EMBODIMENT

Hereinbelow, a diagnostic imaging support apparatus 1 of an embodiment of the present invention will be described with reference to the drawings.

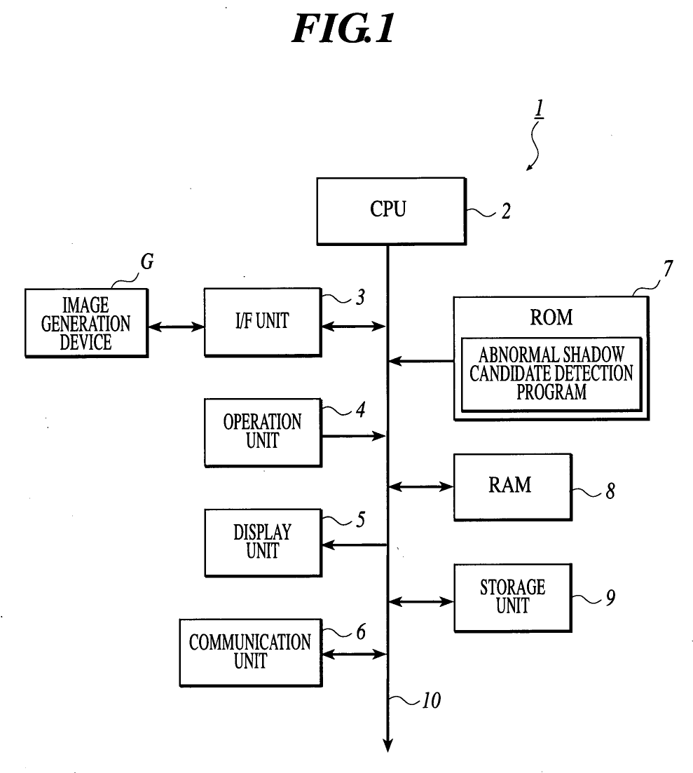

First, a schematic configuration of the diagnostic imaging support apparatus 1 will be described. As shown in FIG. 1, the diagnostic imaging support apparatus 1 includes: a CPU (Central Processing Unit) 2, an I/F (InterFace) unit 3, an operation unit 4, a display unit 5, a communication unit 6, a ROM (Read Only Memory) 7, a RAM (Random Access Memory) 8, a storage unit 9 and the like, and these units are connected through a bus 10.

The CPU 2 develops in a work area of the RAM 8 programs specified from various programs stored in the ROM 7, in accordance with various instructions inputted through the operation unit 4 and data inputted through the I/F unit 3 or the communication unit 6. The CPU 2 performs various processing in cooperation with the programs, stores the results of the processing in a predetermined area of the RAM 8, and causes the display unit 5 to display the results thereon.

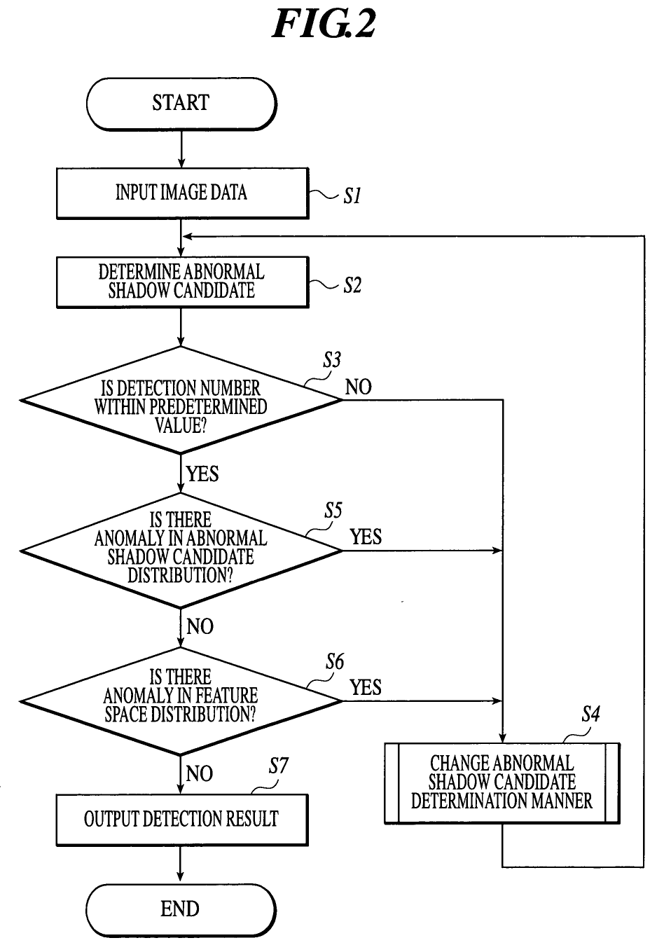

The CPU 2 determines whether or not shadows contained in the image data are abnormal shadows, and detects abnormal shadow candidates. The CPU 2 then judges the state of the detection of the abnormal shadow candidates, changes the manner of determining whether or not the shadows are abnormal shadows, based on the judgment of the state of the detection, and determines again whether or not the shadows are abnormal shadows based on the changed determination manner (refer to FIG. 2).

The CPU 2 includes a function as a recording unit to record, as information attached to the image data stored in the storage unit 9, how many times the methods of determining abnormal shadow candidates are changed, the kinds of changed determination manners, or the criteria of changing the determination manners are changed.

The I/F unit 3 is an interface to connect the diagnostic support apparatus 1 to an image generation device G, and image data generated in the image generation device G is inputted to the diagnostic imaging support apparatus 1.

To the image generating device G, applicable are: a laser digitizer which obtains image data by scanning with laser beam a film on which a medical image obtained by imaging a subject is recorded; a film scanner which obtains image data recorded on a film by using a sensor of a photoelectric conversion element such as a CCD (Charge Coupled Device); and the like.

The method of inputting image data is not particularly limited, and, instead of reading a medical image recorded on a film, an imaging device to take a medical image using accumulative phosphor, a flat panel detector which includes a capacitor and a radiation detection element and generates electric charge in accordance with the intensity of the radiation applied, and the like, may be configured to be connectable to the diagnostic imaging support apparatus 1.

The operation unit 4 comprises a keyboard which includes cursor keys, a numerical keypad and various function keys. The operation unit 4 outputs to the CPU 2 a press signal generated through each key operation. The operation unit 4 may comprise a pointing device such as a mouse and a touch panel, and other input devices as necessary.

The display unit 5 comprises an LCD (Liquid Crystal Display) and the like, and displays various display information such as a medical image and a result of detection of abnormal shadow candidates performed by the CPU 2.

The communication unit 6 comprises a communication interface such as a network interface card, a modem, and a terminal adapter, and transmits and receives various information to and from an external device on a communication network. For example, image data may be received from the image generation device G through the communication unit 6. Moreover, the diagnostic imaging support apparatus 1 may be connected through the communication unit 6 to a server in a hospital or a medical examination terminal placed in an examination room, to transmit a result of detection of abnormal shadow candidates.

The ROM 7 comprises a nonvolatile semiconductor memory and stores various programs to be executed by the CPU 2. An abnormal shadow candidate detection program is stored in the ROM 7, and an abnormal shadow candidate detection unit is realized by cooperation between the program and the CPU 2.

The RAM 8 comprises a rewritable semiconductor element. The RAM 8 is a storage medium to temporarily save data thereon. In the RAM 8, there are formed a program area for developing a program executed by the CPU 2, a data area for saving such as various results of the processing performed by the CPU 2, and the like.

The storage unit 9 comprises a magnetooptic recording medium, a semiconductor memory, or the like. The storage unit 9 stores image data inputted from the image generation device G through the I/F unit 3 or image data received through the communication unit 6, subject information, conditions for imaging, feature quantities of the shadow(s) obtained from the image data, and the like.

The subject information includes information obtained by analyzing image data, and information inputted with image data. For example, the information obtained by analyzing image data includes the area of the region to be diagnosed (breast etc.) on the image, density distribution, and the like. Meanwhile, examples of the information inputted with image data include the age, sex, breast thickness (thickness obtained when a constant pressure is realized upon taking an image of the breast being compressed), and the like. The information inputted with the image data may be inputted through the I/F 3 or the communication unit 6, or may be inputted through the operation unit 4.

The conditions for imaging include the date of imaging, region for imaging, direction of imaging, tube potential (voltage applied to a radiation source upon imaging of a radiographic image), and the like. The conditions for imaging may be inputted with the image data through the I/F unit 3 or the communication unit 6, or may be inputted through the operation unit 4.

The feature quantities of shadow(s) include the position(s) of shadow portion(s), size(s) thereof, the number thereof, roundness, degree(s) of irregularity in the shape(s), contrast between the shadow portion(s) and the background image, and the like.

With respect to the position of a shadow portion, the position of the centroid of the shadow portion is shown by coordinate values (for example, (x, y)=(100, 1200) etc.). However, the position may be shown by, for example, coordinate values which indicate the image region of the shadow portion.

The size of a shadow portion is indicated by an area occupied by the image region of the shadow portion, or may be shown by the average distance or the longest distance from the centroid of the shadow portion to the margins thereof.

Roundness e is a feature quantity which shows complexity in the shape of an object, and is expressed by:
e=4πS/L²
where S is an area of the object, and L is a length of a contour (circumferential length) of the object. Alternatively, the roundness e may be expressed by:
e=U/S
where U is an overlapping area (overlap area) between the object and a circle which has the same area as the area S of the object and the center at the centroid of the object. As the shape of the object becomes closer to a circle, the roundness e becomes larger to approach 1.

Irregularity f is expressed by:
f=L′/L
where L is a circumferential length of the object, and L′ is a circumferential length obtained after the circumferential length of the object is made flat and smooth.

The contrast between a shadow portion and a background image thereof is shown by a density difference between the density of the shadow portion and the density of the background image. However, the contrast may be shown by a brightness difference between the brightness of the shadow portion and the brightness of the background image.

Next, an operation in this embodiment will be described.

FIG. 2 is a flowchart for explaining abnormal shadow candidate detection processing performed by the diagnostic imaging support apparatus 1. Hereinafter, the processing body in each step is assumed to be the CPU 2 unless otherwise stated. Here, a description will be given of an example using as medical image data a mammogram obtained by radiographing a breast. However, the target region is not limited thereto, and may be chest, abdomen, or the like. Upon detecting abnormal shadow candidates from a mammogram, abnormal shadow candidate detection processing is performed for each kind of lesions as targets, including a tumor density lesion, a cluster of microcalcification, a focal asymmetric density, and architectural distortion, which are characteristic of breast cancer.

As shown in FIG. 2, first, image data is inputted through the I/F unit 3 or the communication unit 6 (Step S1), and stored in the storage unit 9. Among subject information, information inputted with the image data and conditions for imaging are inputted through the I/F unit 3 or the communication unit 6, and stored in the storage unit 9. The above information may be inputted from the operation unit 4.

Subsequently, the image data is subjected to image analysis, and whether or not shadows contained in the image data are abnormal shadows is determined, thus detecting abnormal shadow candidates (Step S2). A tumor density, a cluster of microcalcification, and the like are examples of abnormal shadows. A tumor density is a lump with a certain amount of size, and is observed on a mammogram as a round whitish shadow similar to Gaussian distribution. A cluster of microcalcification, which is made up of gathered (clustered) microcalcifications, is observed on a mammogram as a round whitish shadow with an inverted cone structure.

Now a description will be given of feature quantity analysis for determining whether or not the shadows are abnormal shadows. Calculation is performed to obtain various feature quantities of each shadow in the image data, such as position information, roundness, contrast, an intensity component of the density gradient from the circumferential portion to the central portion of the shadow, and a direction component. Based on threshold values set to the respective calculated feature quantities, the shadows are determined to be true positive or false positive. Alternatively, a shadow may be determined to be true positive or false positive based on threshold values set to a plurality of feature quantities, and may be detected as an abnormal shadow candidate when the shadow is determined to be true positive with respect to all of the plurality of feature quantities.

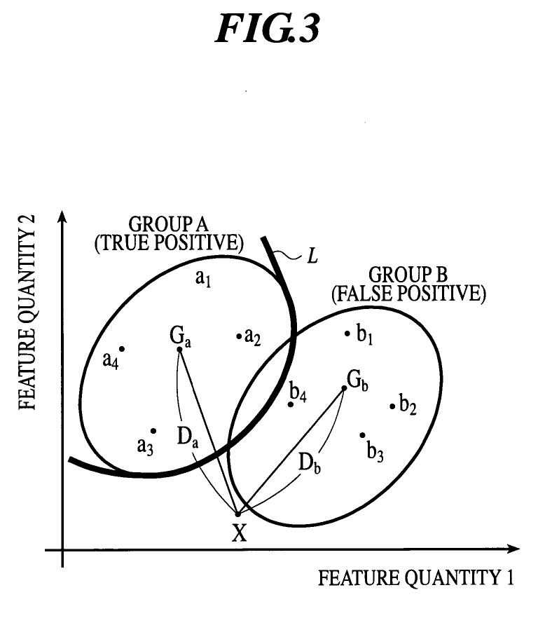

Next, multivariate analysis using a plurality of feature quantities will be explained. In discriminant analysis in multivariate analysis, sample data belonging to two or more groups are prepared beforehand, and to which group the discrimination target data belongs is determined. With reference to FIG. 3, an example of the discriminant analysis using Mahalanobis distance will be explained. Mahalanobis distance is a distance from the center of each group, in consideration of distribution of sample data, to the discrimination target data. In FIG. 3, sample data are plotted with feature quantity 1 and feature quantity 2 as two variables. As shown in FIG. 3, two groups including a group A consisting of true positive sample data a1-a4 and a group B consisting of false positive sample data b1-b4 are prepared beforehand, and a Mahalanobis distance Da from a center Ga of the group A and a Mahalanobis distance Db from a center Gb of the group B are obtained for discrimination target data X. Based on the distance ratio Da/Db, to which group the discrimination target data X belongs is determined. When the distance ratio Da/Db is equal to or smaller than a threshold value (for example, 1), the discrimination target data X is close to the group A and thus determined to be true positive, and when the distance ratio Da/Db is larger than a threshold value, the discrimination target data X is close to the group B and thus determined to be false positive. In FIG. 3, there is shown a boundary line L_{B} between true positive and false positive based on the Mahalanobis distance ratio. The Mahalanobis distance ratio on this boundary line L_{B} corresponds to the threshold value.

By such methods, shadows determined to be true positive are detected as abnormal shadow candidates, and abnormal shadow candidate information, such as the kinds of lesions and feature quantities of the abnormal shadow candidates, is stored in the storage unit 9.

Subsequently, whether or not the number of the detected abnormal shadow candidates is within a predetermined value is judged (Step S3). When the number of the detected abnormal shadow candidates is more than the predetermined value (Step S3; No), the abnormal shadow candidate determination manner is changed (Step S4). Based on the changed determination manner, whether or not the shadows are abnormal shadows is determined again, and abnormal shadow candidates are detected.

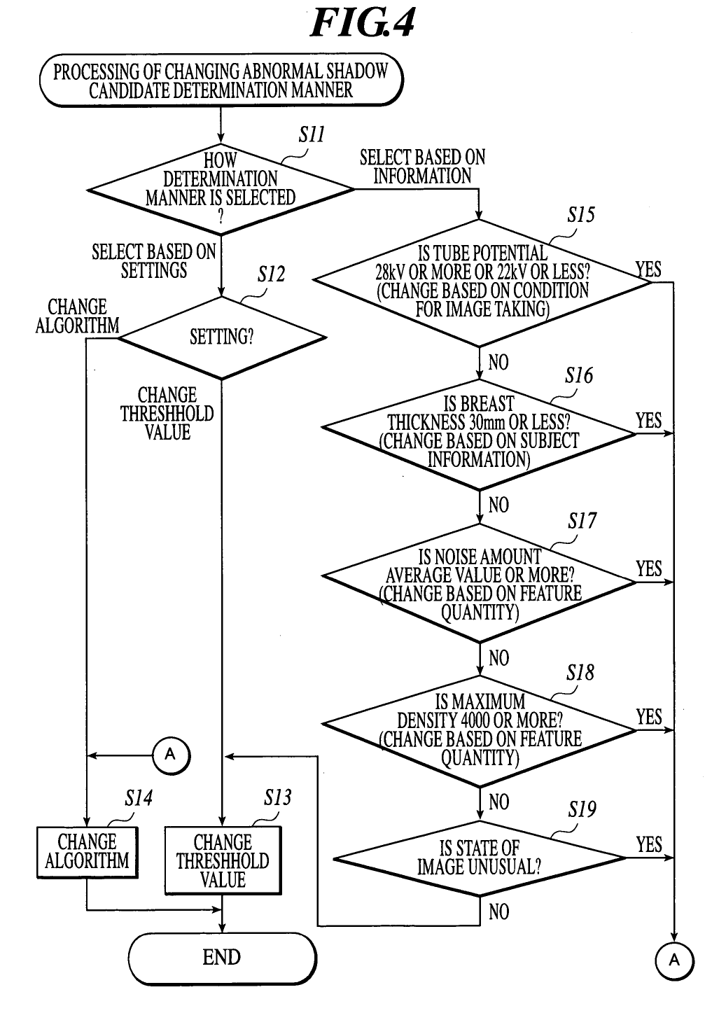

With reference to FIG. 4, processing of changing an abnormal shadow candidate determination manner will be described.

To change an abnormal shadow candidate determination manner, when the determination manner is selected based on setting (Step S11; select based on setting), the abnormal shadow candidate determination manner is changed based on set conditions which are set beforehand. Whether or not the determination manner is selected based on the set conditions which are set beforehand is set by being inputted from the operation unit 4 beforehand.

When it is set that the threshold value is to be changed (Step S12; change threshold value), the threshold value in the feature quantity analysis at the time of determining abnormal shadow candidate or the threshold value in the multivariate analysis using a plurality of feature quantities is changed (Step S13). For example, when the detection number of abnormal shadow candidates is more than a predetermined value, the threshold value is changed to a threshold value set under a more strict condition.

When it is set that an algorithm is to be changed, (Step S12; change algorithm), the algorithm in abnormal shadow candidate detection is changed (Step S14). A different algorithm with a different contrast calculation method, a breast region setting method, and criteria of determining calcification is prepared for an image taken under different condition(s), an image of a breast of an unusual size, an image obtained from a highly deteriorated film, and the like. Moreover, for each resolution of the image, an algorithm suitable for the resolution exists.

When an abnormal shadow candidate determination manner is selected based on information (Step S11; select based on information), whether or not the tube potential used upon taking a radiation image is 28 kV or more, or 22 kV or less is judged (Step S15). When the tube potential is 28 kV or more or 22 kV or less (Step S15; Yes), the algorithm is changed (Step S14).

When the tube potential is more than 22 kV and less than 28 kV (Step S15; No), whether or not the breast thickness is 30 mm or less is judged (Step S16). When the breast thickness is 30 mm or less, (Step S16; Yes), the algorithm is changed (Step S14).

When the breast thickness is more than 30 mm (Step S16; No), whether or not the noise amount in the image is the average value of the facility or more is judged (Step S17). When the noise amount in the image is the average value of the facility or more, (Step S17; Yes), the algorithm is changed (Step S14).

When the noise amount in the image is less than the average value of the facility (Step S17; No), whether or not the maximum density in the image is 4000 or more in 12 bits (4096 gradations) is judged (Step S18). When the maximum density is 4000 or more (Step S18; Yes), the algorithm is changed (Step S14).

When the maximum density is less than 4000 (Step S18; No), whether or not the state of the image is unusual is judged (Step S19). An unusual state of the image is an abnormal state for an image, and examples thereof include a film which has been kept under a highly humid condition and thus the contrast therein is lost, an image which is obliquely cut off, and the like. When the state of the image is unusual (Step S19; Yes), the algorithm is changed (Step S14).

When the state of the image is not unusual (Step S19; No), changed is the threshold value in feature quantity analysis or the threshold value in multivariate analysis performed for abnormal shadow candidate determination (Step S13).

Thus, the processing of changing the abnormal shadow candidate determination manner is completed.

In Step S3 in FIG. 2, when the detection number of abnormal shadow candidates is within the predetermined value (Step S3; Yes), whether or not there is an anomaly in the abnormal shadow candidate distribution is judged (Step S5). The anomaly in the abnormal shadow candidate distribution is judged by comparing images of the right and left breasts, or by quantifying deviation in the abnormal shadow candidate detection result with respect to a specific region. For example, an MLO (Medio-Lateral Oblique) image and a CC (Cranio-Caudal) image, which have different directions of imaging, are compared, and when the number of abnormal shadow candidates detected from the MLO image is ten and the number of abnormal shadow candidates detected from the CC image is one thousand, there is a possibility that noises and/or normal tissues are erroneously detected as abnormal shadow candidates, and it is thought that there is a problem in the abnormal shadow candidate determination manner. Thus, when there is an anomaly in abnormal shadow candidate distribution (Step S5; Yes), the abnormal shadow candidate determination manner is changed (step S4). Then, whether or not the shadows are abnormal shadows is determined again based on the changed determination manner, and abnormal shadow candidates are detected.

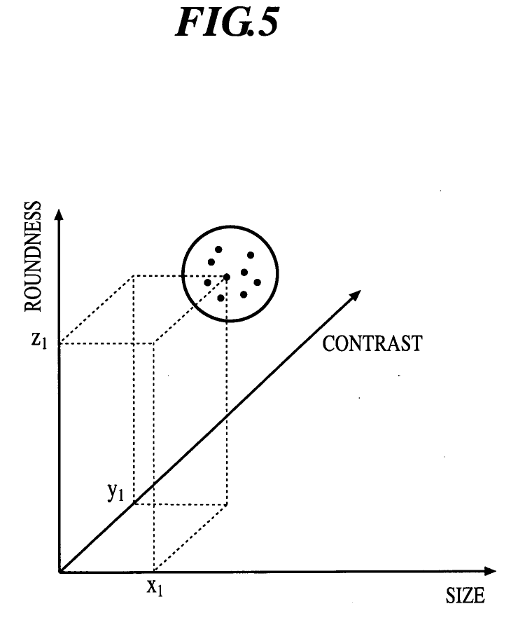

When there is no anomaly in the abnormal shadow candidate distribution (Step S5; No), whether or not there is anomaly in the feature space distribution is judged (Step S6). The anomaly in the feature space distribution is judged, for example, as shown in FIG. 5, according to the spreading states of data when the abnormal shadow candidates are plotted in three dimensions with the size, contrast, and roundness being three variables. Each feature quantity is usually moderately scattered, and thus it is thought to be unusual that feature quantities are concentrated only in a certain area. As shown in FIG. 5, when the sizes, contrasts, and roundnesses of abnormal shadow candidates are concentrated in the vicinity of a point (x1, y1, z1) (that is, many abnormal shadow candidates have similar features), there is a possibility that noises and/or normal tissues are erroneously detected as abnormal shadow candidates, and it is judged that there is an anomaly in the feature space distribution. Here, an example using the size, contrast and roundness of an abnormal shadow candidate is shown; however, the number of feature quantities or the kinds of feature quantities in the feature space are not limited thereto. When there is an anomaly in the feature space distribution (Step S6; Yes), the abnormal shadow candidate determination manner is changed (step S4). Then, whether or not the shadows are abnormal shadows is determined again based on the changed determination manner, and abnormal shadow candidates are detected.

When there is no anomaly in the feature space distribution (Step S6; No), the detection result is displayed on the display unit 5 (Step S7). To be concrete, the abnormal shadow candidates on the image data are shown by a marker, and any one or a combination of the number of changed abnormal shadow candidate determination manners, the kinds of changed determination manners, and the criteria of changing the determination manners are selectively shown. Here, the kinds of changed determination manners include a change of a threshold value in the feature quantity analysis or multivariate analysis performed for abnormal shadow candidate determination, and a change of an algorithm in abnormal shadow candidate detection. The criteria of changing the determination manners are, for example, in FIG. 4, the tube potential, breast thickness, noise amount, maximum density and the like. Further, the number of changed abnormal shadow candidate determination manners, the kinds of changed determination manners, and the criteria of changing the determination manners are recorded as information attached to the image data.

Thus, the abnormal shadow candidate detection processing is completed.

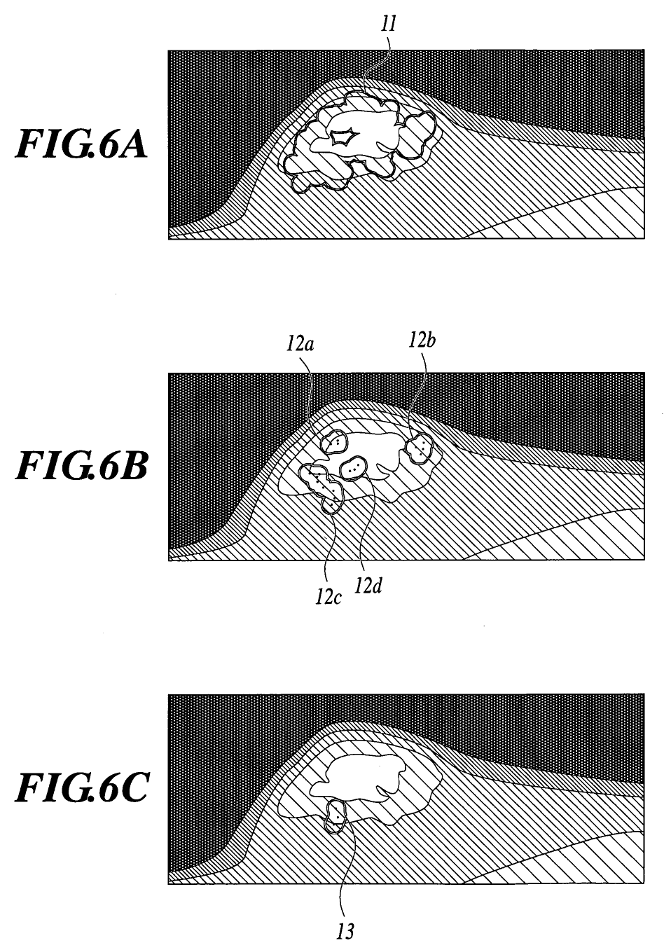

In FIGS. 6A, 6B and 6C, results of detecting clusters of microcalcification from a mammogram as abnormal shadow candidates are shown in steps. In FIG. 6A, an area 11 determined as an abnormal shadow candidate occupies a wide area in the breast, and thus this image is not suitable for diagnosis. Accordingly, the abnormal shadow candidate determination manner is changed, and detection of abnormal shadow candidates is performed again. The detection result thereof is shown in FIG. 6B. In FIG. 6B, areas 12a, 12b, 12c and 12d which are determined to be abnormal shadow candidates are smaller than the area in FIG. 6A; however, there is still a possibility of erroneous detection. By further changing the abnormal shadow candidate determination manner, an abnormal shadow candidate 13 is detected as shown in FIG. 6C.

As described above, according to the diagnostic imaging support apparatus 1, the state of the detection is judged, the method of determining whether or not shadows are abnormal shadows is changed based on the state of the detection, and detection of abnormal shadow candidates is performed again. Thus, abnormal shadow candidates are detectable with high accuracy.

For example, by changing an abnormal shadow candidate determination manner based on the detection number of abnormal shadow candidates, excessive detection where unusual number of abnormal shadow candidates are detected due to noises and the like can be reduced. Further, by changing an abnormal shadow candidate determination manner based on abnormal shadow candidate distribution, there is an advantageous effect that false positive candidates of which state of distribution includes an anomaly are excluded. Furthermore, by changing an abnormal shadow candidate determination manner based on statistical values of feature quantities, false positive candidates concentrated in a predetermined feature space can be excluded.

Moreover, since the number of changed abnormal shadow determination manners, the kinds of the changed determination manners, and the criteria of changing the determination manners are displayed on the display unit 5 and recorded as information attached to the image data, the number of changed abnormal shadow determination manners, the kinds of changed determination manners, and the criteria of changing the determination manners can be notified to the user.

It should be noted that the description in the above embodiment is a preferred embodiment of a diagnostic imaging support apparatus according to the present invention, and thus the diagnostic imaging support apparatus of the invention is not limited thereto. The detailed structure of each composition constituting the diagnostic imaging support apparatus and the detailed operations thereof can be changed as appropriate without departing from the spirit of the invention.

In the above embodiment, in processing of changing the abnormal shadow determination manners (FIG. 4), the tube potential, breast thickness, noise amount, maximum density and state of the image are used as criteria of selecting a determination manner based on information. However, conditions for imaging other than the tube potential, subject information other than the breast thickness, and feature quantities other than the noise amount and maximum density can be used as criteria of judgment.

It is also possible that a calculation time is stored for each of the various feature quantities, and, when the calculation time of a feature quantity is abnormal (when the calculation time is extraordinarily longer or shorter than a normal calculation time), such a feature quantity is not used.

Moreover, it is possible to set a predetermined calculation time (for example, a normal calculation time) for each calculation algorithm of the respective feature quantities, and, when the calculation time of a feature quantity has exceeded the corresponding set calculation time, the calculation is stopped and the feature quantity is not used.

The entire disclosure of Japanese Patent Application No. Tokugan 2004-69419 filed on Mar. 11, 2004 is incorporated herein by reference in its entirety.

1. A diagnostic imaging support apparatus comprising:
an abnormal shadow candidate detection unit to perform detection of an abnormal shadow candidate by performing determination as to whether or not a shadow contained in a medical image obtained by imaging a subject is an abnormal shadow; and
an image display unit to display the medical image thereon,
wherein the abnormal shadow candidate detection unit comprises a judging unit to judge a state of the detection of the abnormal shadow candidate, and a changing unit to change a determination manner of the determination as to whether or not the shadow is an abnormal shadow based on the judged state of the detection.

2. The apparatus of claim 1, wherein a target of the detection of the abnormal shadow candidate is a cluster of microcalcification in a breast.

3. The apparatus of claim 1, wherein a target of the detection of the abnormal shadow candidate is a tumor density lesion in a breast.

4. The apparatus of claim 1, wherein the judging unit judges the state of the detection based on any one of or a combination of the detection number of the abnormal shadow candidate, a distributed state of the abnormal shadow candidate, a statistical value of a feature quantity of the abnormal shadow candidate, and a calculation time of the feature quantity.

5. The apparatus of claim 1, wherein the changing unit changes the determination manner based on any one of or a combination of a condition for imaging of the subject, subject information on the subject, a feature quantity of the abnormal shadow candidate, and an image state of the medical image.

6. The apparatus of claim 1, wherein the changing unit changes the determination manner based on a predetermined set condition.

7. The apparatus of claim 1, wherein the changing unit changes a threshold value used for feature quantity analysis, or a threshold value used for multivariate analysis which uses a plurality of feature quantities, when performing the determination as to whether or not the shadow is an abnormal shadow.

8. The apparatus of claim 1, wherein the changing unit changes an algorithm.

9. The apparatus of claim 1, further comprising: a recording unit to record any one of the number of changing of a determination manner by the changing unit, a kind of the changed determination manner, and a criterion of changing the determination manner; or a display unit to display any one of the number of changing of a determination manner by the changing unit, a kind of the changed determination manner, and a criterion of changing the determination manner.

10. A diagnostic imaging support method comprising:
detecting an abnormal shadow candidate by performing determination as to whether or not a shadow contained in a medical image obtained by imaging a subject is an abnormal shadow; and
displaying the medical image,
wherein the detecting comprises judging a state of the detecting of the abnormal shadow candidate, and changing a determination manner of the determination as to whether or not the shadow is an abnormal shadow based on the judged state of the detecting.

11. The method of claim 10, wherein a target of the detecting of the abnormal shadow candidate is a cluster of microcalcification in a breast.

12. The method of claim 10, wherein a target of the detecting of the abnormal shadow candidate is a tumor density lesion in a breast.

13. The method of claim 10, wherein the judging the state of the detecting is performed based on any one of or a combination of the detection number of the abnormal shadow candidate, a distributed state of the abnormal shadow candidate, a statistical value of a feature quantity of the abnormal shadow candidate, and a calculation time of the feature quantity.

14. The method of claim 10, wherein the changing the determination manner is performed based on any one of or a combination of a condition for imaging of the subject, subject information on the subject, a feature quantity of the abnormal shadow candidate, and an image state of the medical image.

15. The method of claim 10, wherein the changing the determination manner is performed based on a predetermined set condition.

16. The method of claim 10, wherein the changing changes a threshold value used for feature quantity analysis, or a threshold value used for multivariate analysis which uses a plurality of feature quantities, when performing the determination as to whether or not the shadow is an abnormal shadow.

17. The method of claim 10, wherein the changing changes an algorithm.

18. The method of claim 10, further comprising: recording any one of the number of changing of a determination manner by the changing unit, a kind of the changed determination manner, and a criterion of changing the determination manner; or displaying any one of the number of changing of a determination manner by the changing unit, a kind of the changed determination manner, and a criterion of changing the determination manner.
